(19) United States
(12) Patent Application Publication
(10) Pub. No.: US 2026/0006004 A1
(43) Pub. Date: Jan. 1, 2026

(54) VIRTUAL PRIVATE NETWORK (VPN) TUNNELING OVER A DATA NETWORK COMBINING BOTH ENCRYPTED AND UNENCRYPTED DATA STREAMS

(71) Applicant: Fortinet, Inc., Sunnyvale, CA (US)

(72) Inventor: Jacob Leigh Burkholder, Antioch, CA (US)

(73) Assignee: Fortinet, Inc., Sunnyvale, CA (US)

(21) Appl. No.: 18/759,964

(22) Filed: Jun. 30, 2024

(51) Int. Cl. H04L 9/40

(52) U.S. Cl. CPC H04L 63/0272

(57) ABSTRACT

For a new network session, it is determined whether to encrypt prior to transmitting over the VPN channel. Unencrypted is sent over the outer VPN channel and encrypted is sent over the inner VPN channel. The inner VPN channel is established over the outer VPN channel. A session table is updated with the new session. Responsive to being sent over the unencrypted VPN channel, encryption is bypassed prior to transmitting over the unencrypted VPN channel, and responsive to being sent over the encrypted VPN channel, sends the new session for encryption prior to transmitting over the encrypted VPN channel. The unencrypted VPN channel also bypasses decryption upon receipt.

### FIELD OF THE INVENTION

The invention relates generally to computer networks, and more specifically, for managing a combination of unencrypted streams and encrypted streams over a virtual private network (VPN) channel.

### BACKGROUND

The invention seeks to reduce the overhead and/or improve the maximum throughput of vpn protocol processing

What is needed is a robust technique for managing a combination of unencrypted streams and encrypted streams over a VPN channel.

### SUMMARY

To meet the above-described needs, methods, computer program products, and systems for managing a combination of unencrypted streams and encrypted streams over a VPN channel.

In one embodiment, a VPN tunnel is established between two or more endpoints and a session table is populated with designated destination addresses for VPN tunneling, and wherein the session table designated which of the destination addresses do not need encryption.

In another embodiment, a new session of network traffic is detected. In response, it is determined from destination address whether to use a VPN or non-VPN channel based on whether the destination address has been designated for VPN traffic based on the session table, and if the VPN channel. Next, it is determined whether to encrypt prior to transmitting over the VPN channel. Unencrypted is sent over the outer VPN channel and encrypted is sent over the inner VPN channel. The inner VPN channel is established over the outer VPN channel. A session table is updated with the new session.

In still another embodiment, responsive to being sent over the unencrypted VPN channel, encryption is bypassed prior to transmitting over the unencrypted VPN channel, and responsive to being sent over the encrypted VPN channel, sends the new session for encryption prior to transmitting over the encrypted VPN channel. The unencrypted VPN channel also bypasses decryption upon receipt. Advantageously, computer performance is improved by saving resources.

### BRIEF DESCRIPTION OF THE DRAWINGS

In the following drawings, like reference numbers are used to refer to like elements. Although the following figures depict various examples of the invention, the invention is not limited to the examples depicted in the figures.

FIGS. 1A-B are high-level block diagram illustrating aspects of a system for managing a combination of unencrypted streams and encrypted streams over a VPN channel, according to some embodiments.

FIG. 2 is a more detailed block diagram illustrating a VPN server of the system of FIG. 1, according to an embodiment.

FIG. 3 is a more detailed block diagram illustrating data packet headers for an outer tunnel and an inner tunnel, according to an embodiment.

FIG. 4 is a high-level flow diagram illustrating a method for managing a combination of unencrypted streams and encrypted streams over a VPN channel, according to an embodiment.

FIG. 5 is a flow diagram illustrating a step of automatically associating a surveillance security policy with a user on video based on Wi-Fi data, from the method of FIG. 5, according to an embodiment.

FIG. 6 is a block diagram illustrating an example computing device for the system of FIG. 1, according to an embodiment.

### DETAILED DESCRIPTION

Methods, computer program products, and systems for managing a combination of unencrypted streams and encrypted streams over a VPN channel. The following disclosure is limited only for the purpose of conciseness, as one of ordinary skill in the art will recognize additional embodiments given the ones described herein.

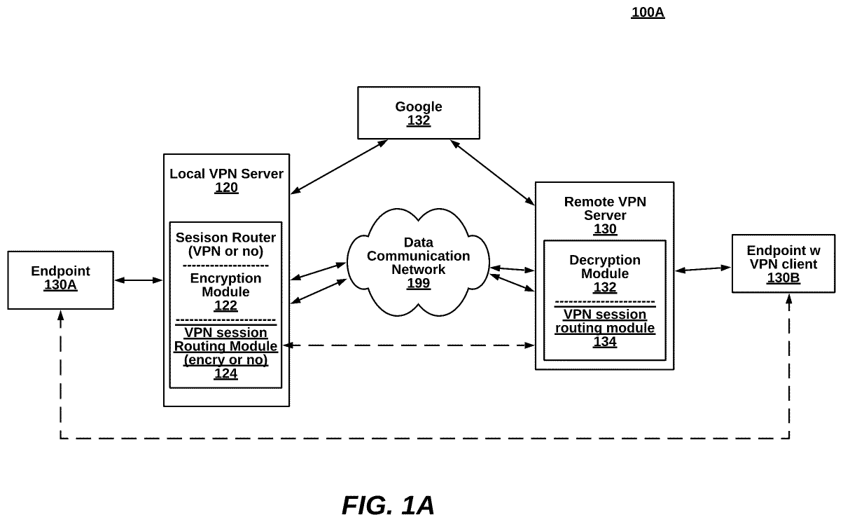

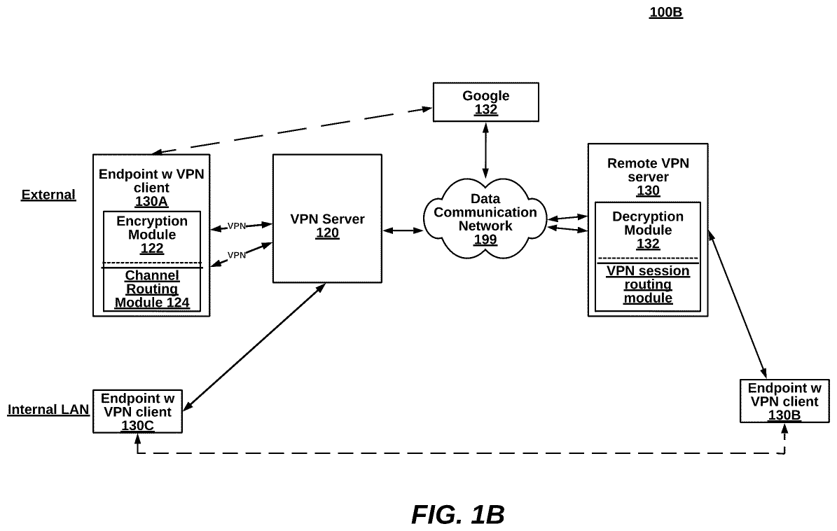

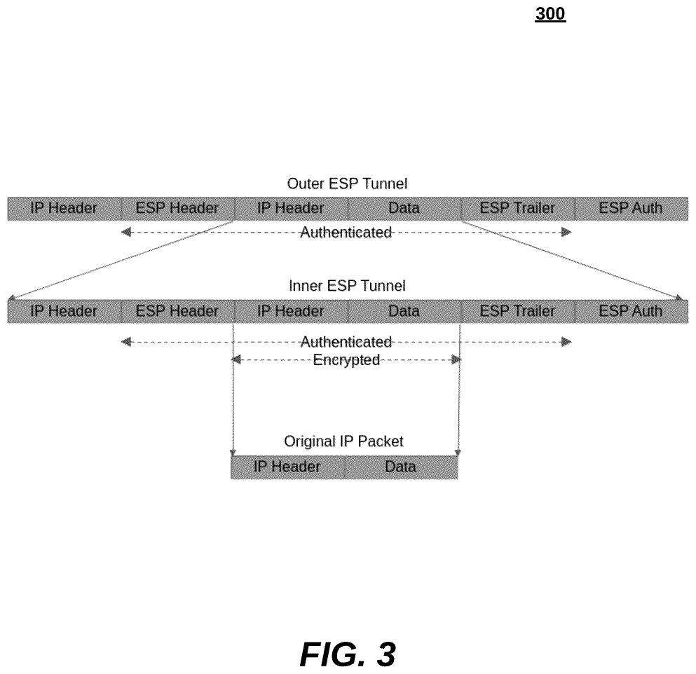

### I. Systems for Combination VPN Data Streams (FIGS. 1-3)

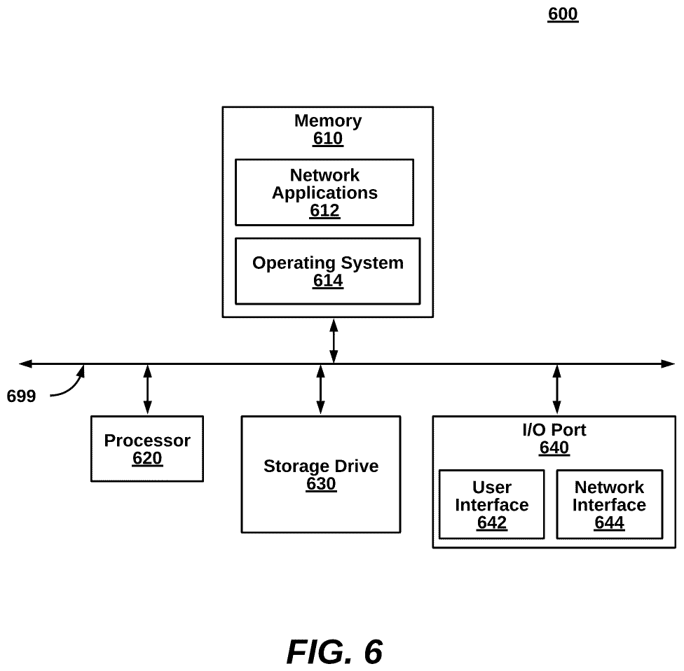

FIGS. 1A and 1B are high-level block diagram illustrating a systems 100A, B for managing a combination of unencrypted streams and encrypted streams over a VPN channel, according to an embodiment. The system 100 includes a local VPN server 110, a remote VPN server 120, and endpoints 105 and 195, and endpoints 130A-C each associated with a person, on a data communication network. Other embodiments of the system 100 can include additional components that are not shown in FIG. 1, such as routers, switches, network gateways, and firewalls, and access points. Further, there can be more VPN servers and endpoints The components of system 100 can be implemented in hardware, software, or a combination of both. An example implementation is shown in FIG. 6.

While FIG. 1A shows a system 100A within an enterprise network, FIG. 1B shows a system 100B external to the enterprise network. In more detail, the local VPN server 120 of FIG. 1A holds VPN functionality from the session router 121, the encryption module 122 and the VPN session routing module 124. Meanwhile, in FIG. 1B, the endpoint 130A holds VPN functionality. In this case, a user may use VPN software from home to tunnel into the enterprise network. In one embodiment, when a user uses a VPN tunnel into an enterprise network, the second VPN tunnel from a local to a remote LAN can bypass encryption since the incoming stream to the second VPN tunnel is already encrypted. At the remote VPN server 130 a decryption module 132 can decrypt from the VPN tunnel, or if there was no further encryption, decryption can be bypassed. In one case, the messaging application, What's App, organically provides end-to-end encryption, and thus, does not need to be further encrypted for the purpose of VPN.

In one embodiment, the components of the system 100 are coupled in communication over a private network connected to a public network, such as the Internet. In another embodiment, system 100 is an isolated, private network, or alternatively, a set of geographically dispersed LANs. The components can be connected to the data communication system via hard wire (e.g., VPN servers 110, 120 and endpoints 105, 195 130A-C). The components can also be connected via wireless networking (e.g., end points 105, 195). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802, 11r, 802.11be, Wi-Fi 6, Wi-Fi 6E, Wi-Fi 7 and the like. Components can use IPV4 or Ipv6 address spaces.

Initially, session router 121 tracks whether sessions are subject to VPN tunneling or not. In one embodiment, the local VPN server 120 builds a tunnel between local and remote enterprise networks. In one case, an inner tunnel and an outer tunnel separates traffic that is encrypted by the local VPN server 120 and traffic that is not encrypted, because it is already encrypted.

The endpoints 105, 195 can be a personal computer, a laptop, a smartphone, a tablet, a terminal, or any other appropriate processor-driven device.

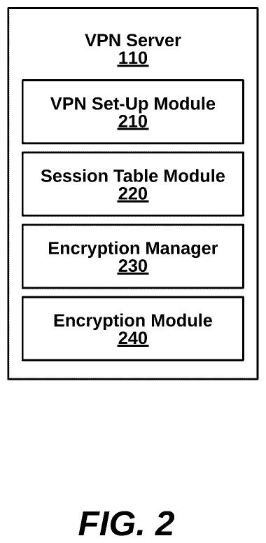

FIG. 2 is a more detailed block diagram illustrating the VPN server 110 of the system of FIG. 1, according to one embodiment. The phishing e-mail database 110 includes a VPN set-up module 210, a session table module 220, an encryption manager 230, and an encryption module 240. The components can be implemented in hardware, software, or a combination of both.

The VPN set-up module 210 can establish a VPN tunnel between two or more endpoints and populate a session table with designated destination addresses for VPN tunneling, and wherein the session table designated which of the destination addresses do not need encryption.

The session table module 220 detects a new session of network traffic. Parameters can be saved in a table. For example, an indication of whether a session can bypass encryption. One embodiment only bypasses encryption if the existing encryption satisfies certain requirements.

The encryption manager 230 determines from destination address whether to use a VPN or non-VPN channel based on whether the destination address has been designated for VPN traffic based on the session table, and if the VPN channel, determine whether to encrypt prior to transmitting over the VPN channel, wherein unencrypted is sent over the outer VPN channel and encrypted is sent over the inner VPN channel, and wherein the inner VPN channel is established over the outer VPN channel. session table is updated with the new session,

In another embodiment, the encryption manager 230, responsive to being sent over the unencrypted VPN channel, bypasses encryption prior to transmitting over the unencrypted VPN channel, and responsive to being sent over the encrypted VPN channel, sends the new session for encryption prior to transmitting over the encrypted VPN channel. The unencrypted VPN channel can also bypass decryption upon receipt.

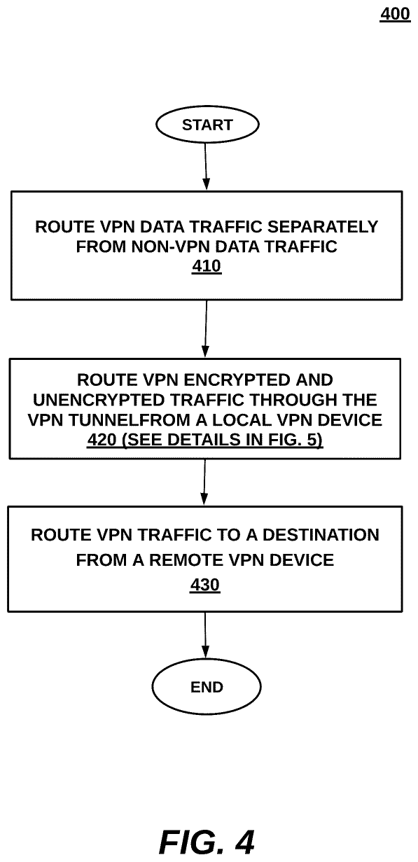

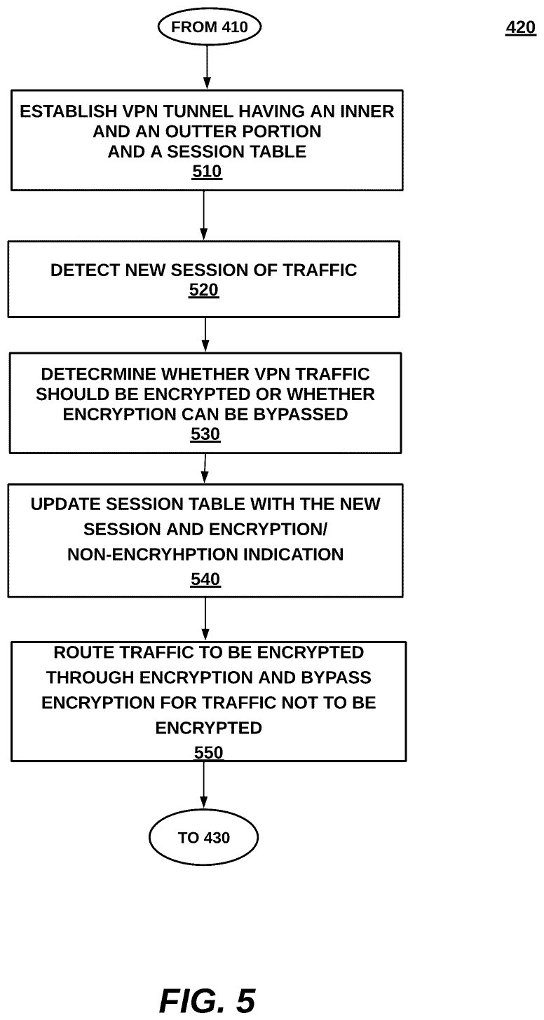

### II. Methods for Combination VPN Data Streams (FIGS. 4-5)

FIG. 4 is a high-level flow diagram of a method 400 for managing a combination of unencrypted streams and encrypted streams over a VPN channel, according to an embodiment. The method 400 can be implemented by, for example, system 100 of FIG. 1. The specific grouping of functionalities and order of steps are a mere example as many other variations of method 400 are possible, within the spirit of the present disclosure. Other variations are possible for different implementations.

At step 410, VPN traffic is routed separately from non-VPN traffic. At step 420, combined encrypted and unencrypted data streams are routed through the VPN tunnel by a local VPN device, as described further in reference to FIG. 5. At step 430, the VPN traffic is routed to a destination from a remote VPN device.

FIG. 5 provides more detail for the VPN routing step 420. At step 510, a VPN tunnel is established between two or more endpoints and populate a session table with designated destination addresses for VPN tunneling. The session table can designate which of the destination addresses do not need encryption.

At step 520, a new session of network traffic can be detected. Existing sessions should already be listed in the session table with instructions.

At step 530, it is determined from destination address whether to use a VPN or non-VPN channel based on whether the destination address has been designated for VPN traffic based on the session table, and if the VPN channel, determine whether to encrypt prior to transmitting over the VPN channel. Unencrypted is sent over the outer VPN channel and encrypted is sent over the inner VPN channel. The inner VPN channel is established over the outer VPN channel.

At step 540, a session table is updated with the new session and encryption/non-encryption indication.

At step 550, responsive to being sent over the unencrypted VPN channel, encryption is bypassed prior to transmitting over the unencrypted VPN channel, and responsive to being sent over the encrypted VPN channel, the new session I sent for encryption prior to transmitting over the encrypted VPN channel. The unencrypted VPN channel also bypasses decryption upon receipt.

### III. Computing Device for Combination VPN Data Streams (FIG. 6)

FIG. 6 is a block diagram illustrating a computing device 600 for use in the system 100 of FIG. 1, according to one embodiment. The computing device 600 is a non-limiting example device for implementing each of the components of the system 100, including VPN servers 120,130 e-mail server 120, and endpoints 130A-C. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog, and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7 or Windows 8), Linux, HP-UX, UNIX, Sun OS, Solaris, Mac OS X, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, Javascript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11 g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VOIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use. The scope of the invention is defined by the following claims.

I claim:

1. A computer-implemented method in a VPN device, on a data communication network, for managing a combination of unencrypted streams and encrypted streams over a VPN channel, the method comprising:
establishing a VPN tunnel between two or more endpoints and populate a session table with designated destination addresses for VPN tunneling, and wherein the session table designated which of the destination addresses do not need encryption;
detecting a new session of network traffic;
determining from destination address whether to use a VPN or non-VPN channel based on whether the destination address has been designated for VPN traffic based on the session table, and if the VPN channel, determine whether to encrypt prior to transmitting over the VPN channel, wherein unencrypted is sent over the outer VPN channel and encrypted is sent over the inner VPN channel, and wherein the inner VPN channel is established over the outer VPN channel;
updating a session table with the new session,
responsive to being sent over the unencrypted VPN channel, bypassing encryption prior to transmitting over the unencrypted VPN channel, and responsive to being sent over the encrypted VPN channel, sends the new session for encryption prior to transmitting over the encrypted VPN channel, and
wherein the unencrypted VPN channel also bypasses decryption upon receipt.

2. A non-transitory computer-readable medium in a video surveillance system, on a data communication network, storing code that when executed, performs a method for automatically associating a surveillance security policy with a user on video based on Wi-Fi data, the method comprising:
establishing a VPN tunnel between two or more endpoints and populate a session table with designated destination addresses for VPN tunneling, and wherein the session table designated which of the destination addresses do not need encryption;
detecting a new session of network traffic;
determining from destination address whether to use a VPN or non-VPN channel based on whether the destination address has been designated for VPN traffic based on the session table, and if the VPN channel, determine whether to encrypt prior to transmitting over the VPN channel, wherein unencrypted is sent over the outer VPN channel and encrypted is sent over the inner VPN channel, and wherein the inner VPN channel is established over the outer VPN channel;
updating a session table with the new session,
responsive to being sent over the unencrypted VPN channel, bypassing encryption prior to transmitting over the unencrypted VPN channel, and responsive to being sent over the encrypted VPN channel, sends the new session for encryption prior to transmitting over the encrypted VPN channel, and
wherein the unencrypted VPN channel also bypasses decryption upon receipt.

3. A video surveillance system, on a data communication network, for automatically associating a surveillance security policy with a user on video based on Wi-Fi data, the video surveillance system comprising:
a processor;
a network interface communicatively coupled to the processor and to a data communication network; and
a memory, communicatively coupled to the processor and storing:
a VPN set-up module to establishing a VPN tunnel between two or more endpoints and populate a session table with designated destination addresses for VPN tunneling, and wherein the session table designated which of the destination addresses do not need encryption;
a session table to detect a new session of network traffic;
an encryption manager to determine from destination address whether to use a VPN or non-VPN channel based on whether the destination address has been designated for VPN traffic based on the session table, and if the VPN channel, determine whether to encrypt prior to transmitting over the VPN channel, wherein unencrypted is sent over the outer VPN channel and encrypted is sent over the inner VPN channel, and wherein the inner VPN channel is established over the outer VPN channel,
wherein the encryption manager, responsive to being sent over the unencrypted VPN channel, bypasses the session from encryption by assigning the new session to the unencrypted VPN channel, and responsive to being sent over the encrypted VPN channel, sends the session to encryption and then transmitting over the encrypted VPN channel; and
wherein the session table updates the new session with an indication of encrypt or bypass encryption,
wherein the unencrypted VPN channel also bypasses decryption prior to receipt by the receiving.
